(19) United States
(12) Patent Application Publication
(10) Pub. No.: US 2023/0130366 A1
(43) Pub. Date: Apr. 27, 2023

(54) PLEATED AND HONEYCOMB BLINDS SYSTEM

(71) Applicant: PLICELL TEKSTIL SANAYI VE TICARET ANONIM SIRKETI, Osmangazi (TR)

(72) Inventor: Cenk KEMAHLI, Osmangazi (TR)

(21) Appl. No.: 17/510,661

(22) Filed: Oct. 26, 2021

(51) Int. Cl. E06B 9/262

(52) U.S. Cl. CPC E06B 9/262; E06B 2009/2627

(57) ABSTRACT

A pleated and honeycomb blinds system having first blinds that open and close by contacting under the upper profile, a middle profile that open and close by contacting under the first blinds, second blinds that open and close by contacting under the middle profile a rope that connects upper, middle and lower profiles by passing through the first blinds and the second blinds, and a rope fixing apparatus that allows the rope to be fixed to the upper profile and lower profile. The system includes a cover body connected to both ends of the middle profile to ensure the connection of the ropes to the middle profile, a connection element positioned mutually on the cover body, and a middle profile cover between the connection elements and having a pin that holds the ropes coming from the upper profile and the lower profile and moves them on it.

### CROSS-REFERENCE TO RELATED APPLICATIONS

Not applicable.

### BACKGROUND OF THE INVENTION

### 1. Field of the Invention

The invention relates to pleated and honeycomb blinds systems used by connecting on all kinds of fixed, movable, or folding windows, doors, glass balconies.

In particular, the invention relates to two separate pleated or honeycomb blinds systems, which are connected to the middle profile separating the two separate pleated or honeycomb blinds, by means of the middle profile cover, the ropes connecting the two separate pleated or honeycomb blinds and the profiles forming the system are attached to the middle profile cover and moved on a pin, preventing the middle profile from tilting in the upward and downward movement of the two separate pleated or honeycomb blinds and ensuring that the two separate pleated or honeycomb blinds are opened and closed correctly.

### 2. Description of Related Art Including Information Disclosed Under 37 CFR 1.97 and 37 CFR 1.98.

Today, pleated and honeycomb blinds systems, which are similar to roller blinds that replace classic curtains with curtain rods, are widely used in windows, doors, and glass balconies.

Pleated and honeycomb blinds systems generally consist of a single pleated or honeycomb blinds fabric located between the upper profile and the lower profile and opened and closed upwards or downwards on the ropes. It is opened and closed with the upward or downward movement of the upper profile and the lower profile but it provides a functional use by leaving it at the desired place on the glass. Blinds systems consisting of single pleated or honeycomb blinds fabric can work with two separate pleated or honeycomb blinds. For this, two separate pleated or honeycomb blinds are separated from each other by a middle profile between the upper profile and the lower profile. Thus, two separate pleated or honeycomb blinds are used on the glass as tulle or fabric, and functionality has been increased by providing only a curtain or half tulle and half curtain-shaped closure on the glass with the upward-downward movement of the upper profile, middle profile, or bottom profile.

A rope is passed through the pleated and honeycomb blinds in the pleated and honeycomb blinds systems and the upper profile, middle profile, and lower profile were connected to each other via the said rope in the current art. Two separate pleated or honeycomb blinds are opened and closed by moving upwards and downwards on the said ropes. However, the middle profile does not work properly by showing bends when moved upwards and downwards from anywhere except the middle part since the ropes that connect the profiles are not passed through the middle profile covers closed to the edges of the middle profile in current applications. The aforementioned middle profile covers do not have any function as they are closed only to provide an aesthetic appearance to the open ends of the middle profiles. Therefore, there are undesirable bends in the movement of the middle profile, since the ropes are passed directly through the middle profile, but if only the middle profile is moved, other profiles may also move spontaneously. In addition, another problem experienced in current applications is that the middle profile slides downwards when there is a slight loosening in the ropes that should always be tight in the pleated and honeycomb blinds system.

Patent Application No. CN204532000 may be shown as an example of the state of the art as a result of the research conducted on the literature. The aforementioned document relates to a honeycomb polymer fiber blind that can be used day and night. The said invention essentially consists of a blind comprising an upper connecting rod, a middle connecting rod, a lower connecting rod, a day blinds fabric and a night blinds fabric. The blinds are fixed to a blinds frame connected to the wall by means of the upper connecting rod. The day blinds fabric is placed between the upper connecting rod and the middle connecting rod, and the night blinds fabric is placed between the middle connecting rod and the lower connecting rod. In addition, the upper connecting rod is connected to the lower connecting rod by passing a blinds rope from the night blinds fabric, the middle connecting rod and the day blinds fabric. Day blinds and night blinds are opened and closed according to the user's preference in the said invention. However, the connection of blinds fabrics and upper connecting rod, middle connecting rod and lower connecting rod with blinds rope is not mentioned.

Consequently, the foregoing problems and insufficient solutions thereof require to make an improvement in the related technical field.

### OBJECTS OF THE INVENTION

The present invention relates to a pleated and honeycomb blinds system which eliminates the foregoing disadvantages and offers novel advantages to the related technical field.

The main object of the invention is to ensure that the two separate pleated or honeycomb blinds open and close correctly in the upward and downward movement by means of the middle profile cover connected on the middle profile separating the two separate pleated or honeycomb blinds from each other by means of holding the ropes on the middle profile cover and moving them on a pin.

The object of the invention is to ensure that the middle profile separating the two separate pleated or honeycomb blinds functions smoothly without bending, regardless of where they are moved.

Another object of the invention is to prevent the ropes moved on the pin in the pleated and honeycomb blinds system from stopping tightly and unintentionally sliding the middle profile even if it does not stop at the required tension.

Another object of the invention is to solve the problem experienced during the operation of the pleated and honeycomb blinds system without removing all ropes in the blinds system by removing the pin from the middle profile cover.

Another object of the invention is to eliminate the loss of time experienced in maintenance and repair in the pleated and honeycomb blinds system.

Another object of the invention is to prevent the spontaneous movement of any other profile during the upward and downward movement of two separate pleated or honeycomb blinds in the pleated and honeycomb blinds system.

### BRIEF SUMMARY OF THE INVENTION

In order to fulfill all the purposes that may arise from the above-mentioned and detailed description, the invention comprises pleated and honeycomb blinds system, which includes all kinds of fixed, movable or folding windows, doors, upper profile used by contacting on glass balconies, which is opened and closed, first blinds that opens and closes by contacting under the upper profile, second blinds that opens and closes by contacting under the first blinds, second blinds that opens and closes by contacting under the second blinds, a rope that connects upper profile, middle profile, and lower profile by passing through the first blinds and the second blinds, and a rope fixing apparatus that allows the rope to be fixed to the upper profile and lower profile, characterized in that:
pleated and honeycomb blinds systems comprises a cover body connected to both ends of the middle profile to ensure the connection of the ropes to the middle profile, the connection element positioned mutually on the cover body, the middle profile cover between the connection elements and having a pin that holds the ropes coming from the upper profile and the lower profile and moves them on it. The structural and characteristic features and all the advantages of the invention will be understood more clearly by reference to the following figures and the detailed explanation thereof. Therefore, the evaluation should be made by taking these figures and detailed explanations into consideration.

### BRIEF DESCRIPTION OF THE SEVERAL VIEWS OF THE DRAWINGS

FIG. 1 is the perspective view of the disassembled version of the pleated and honeycomb blinds system.

FIG. 2 is the perspective view of the middle profile cover of the pleated and honeycomb blinds system.

FIG. 3 is the side view of the middle profile cover of the pleated and honeycomb blinds system.

FIG. 4 is the upper view of the middle profile cover of the pleated and honeycomb blinds system.

### LIST OF THE REFERENCE NUMBERS

10. Upper profile
20. First blinds
30. Middle profile
40. Second blinds
50. Lower profile
60. Rope
70. Rope fixing apparatus
80. Middle profile cover
81. Cover body
82. Fastener
821. Pin hole
83. Pin
84. Channel
90. Cover

### DETAILED DESCRIPTION OF THE INVENTION

The preferred alternatives of the inventive upper profile (10) are described only for a better understanding of the subject and in such a way that they do not have any restrictive effect in this detailed description.

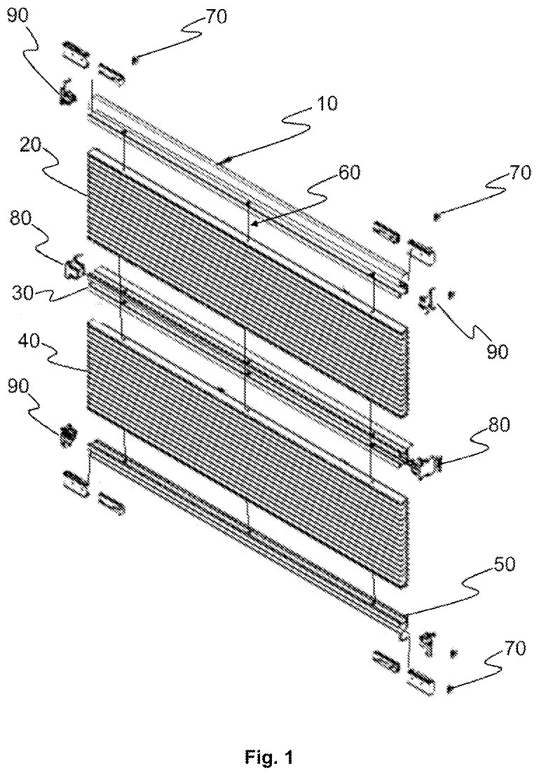

FIG. 1 shows the disassembled view of the pleated and honeycomb blinds system, which is the subject of the invention. Accordingly, the pleated and honeycomb blinds system in its most basic form includes the upper profile (10), which forms the upper edge of the pleated and honeycomb blinds system and enables the pleated and honeycomb blinds system to open and close upwards, the first blinds (20), which is connected to the bottom of the upper profile (10), the middle profile (30), which is connected to the bottom of the first blinds (20) and moves upwards and downwards, the second blinds (40), which is connected to the bottom of the middle profile (30), the lower profile (50), which forms the lower edge of the pleated and honeycomb blinds system by connecting under the second blinds (40) and enables the pleated and honeycomb blinds system to open and close upwards and downwards, the rope (60) connecting the upper profile (10), the middle profile (30) and the lower profile (50) by passing through the first blinds (20) and the second blinds (40), rope fixing apparatus (70) that allows the rope (60) to be fixed to the upper profile (10) and the lower profile (50) as well as to the application area of the pleated and honeycomb blinds system, the middle profile cover (80) connected to both ends of the middle profile (30) and moving the ropes (60) from the upper profile (10) and the lower profile (50) on a pin (83), the cover (90) placed at both open ends of the upper profile (10) and the lower profile (50).

The first blinds (20) and the second blinds (40), which constitute the main structure of the pleated and honeycomb blinds system, are made of pleated fabric, honeycomb fabric, pleated nonwoven surfaces produced by weaving, knitting or different techniques or pleated materials serving the same purpose and ensure that heat and light are controlled in the environment. Both the tulle and the blinds feature are obtained through the same system by using the first blinds (20) and the second blinds (40) in the pleated and honeycomb blinds system.

The first blinds (20) are connected under the upper profile (10), which forms the upper edge of the pleated and honeycomb blinds system in order to open and close the first blinds (20) upwards and downwards. The said upper profile (10) allows the first blinds (20) to be opened and closed when manually moved upwards and downwards, and meanwhile, the pleated blinds or honeycomb blinds system to remain rigid. A cover (90) is placed at both open ends of the upper profile (10).

The lower profile (50), which forms the lower edge of the pleated and honeycomb blinds system, is connected under the second blinds (40) in order to open and close the second blinds (40) upwards and downwards. The said lower profile (50) allows the second blinds (40) to be opened and closed when manually moved upwards and downwards, and meanwhile, the pleated blinds or honeycomb blinds system to remain rigid. A cover (90) is placed at both open ends of the lower profile (50).

The first blinds (20) and the second blinds (40) are joined together by a middle profile (30) that moves upwards and downwards. The middle profile (30) allows the first blinds (20) and/or the second blinds (40) to be opened and closed completely or halfway when manually moved upwards and downwards.

The ropes (60) are passed through the first blinds (20) and the second blinds (40) for upward and downward movement of the first blinds (20) and the second blinds (40). Meanwhile, the upper end of the said ropes (60) is fixed to the rope fixing apparatus (70) connected to the upper profile (10) and the lower end of the ropes (60) is fixed to the rope fixing apparatus (70) connected to the lower profile (50). The ropes (60) fixed to the upper profile (10) and the lower profile (50) by passing through the first blinds (20) and the second blinds (40) are connected to the middle profile (30) by means of the middle profile cover (80) connected to both ends of the middle profile (30).

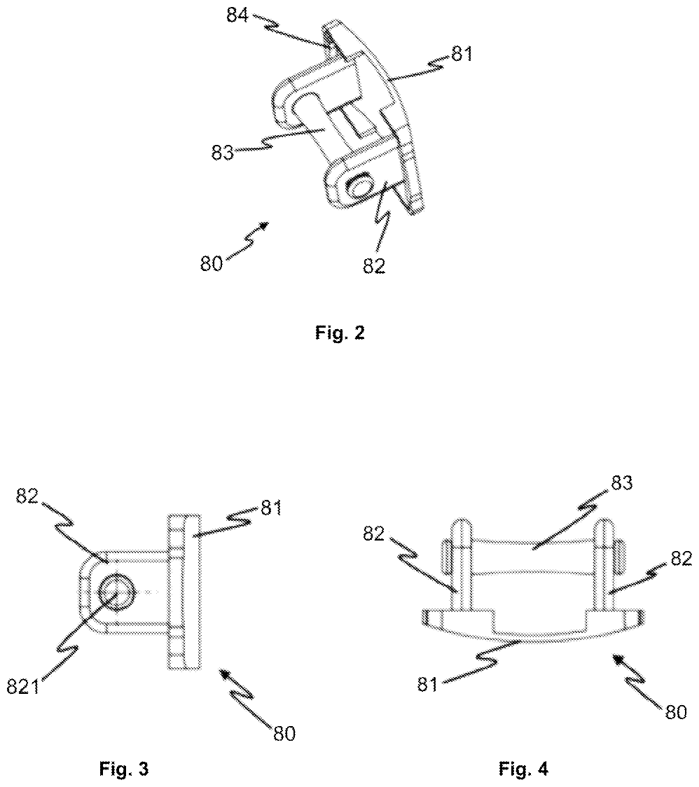

The middle profile cover (80) shown in FIG. 2 consists essentially of a cover body (81), the fasteners (82) positioned mutually on the cover body (81), and a metal or plastic pin (83) connected between the fasteners (82).

The fasteners (82) have a pin hole (821) that secures the pin (83) as shown in FIG. 3. The pin (83) is connected between the fasteners (82) by inserting it into the pin holes (821) as shown in FIG. 4. The said pin (83) moves the ropes (60) fixed to the upper profile (10) and the lower profile (50) by passing through the first blinds (20) and the second blinds (40). Thus, the ropes (60) fixed to the upper profile (10) and the lower profile (50) are connected to the middle profile (30).

A channel (84) is formed on the inner surface of the cover body (81) and the middle profile cover (80) is held by engaging the middle profile (30) by means of the said channel (84) in order to connect the middle profile cover (80) by engaging both ends of the middle profile (30).

The working principle of the pleated blinds or honeycomb blinds system subject to the invention is as follows:

The first blinds (20) are opened or closed when the upper profile (10) and/or the middle profile (30) are manually moved upwards and downwards for use of the first blinds (20). The second blinds (40) are opened or closed when the lower profile (50) and/or the middle profile (30) are manually moved upwards and downwards for use of the second blinds (40). Meanwhile, the ropes (60) connecting the upper profile (10), the middle profile (30), and the lower profile (50) by passing through the first blinds (20) and the second blinds (40) are attached to the middle profile cover (80) and move on the pin (83). Thus, the first blinds (20) and the second blinds (40) are opened and closed properly without bending the middle profile (30) in the upward and downward movement of the pleated and honeycomb blinds system.

I claim:

1. A pleated and honeycomb system that includes an upper profile, which is used by being connected on all kinds of fixed, movable or folding windows, doors, glass balconies, which is opened and closed, first blinds, which are opened and closed by being connected under the upper profile, a middle profile, which is opened and closed by being connected under the first blinds, second blinds, which are opened and closed by being connected under the middle profile, a lower profile, which is moved upwards and downwards by being connected under the second blinds, a rope that connects the upper profile, middle profile, and lower profile by passing through the first blinds and the second blinds, a rope fixing apparatus, which allows the rope to be fixed to the upper profile and the lower profile characterized in that:
the pleated and honeycomb blinds system comprises a cover body connected to both ends of the middle profile to ensure the connection of the ropes to the middle profile, a connection element positioned mutually on the cover body, a middle profile cover between the connection elements and having a pin that holds the ropes coming from the upper profile and the lower profile and moves them on it.

2. The pleated and honeycomb blinds system according to claim 1, wherein it comprises a pin hole on the said fastener that secures the pin.

3. The pleated and honeycomb blinds system according to claim 1, characterized in that it comprises a channel located on the inner surface of the said cover body and enabling the middle profile cover to be held by engaging the middle profile.

4. The pleated and honeycomb blinds system according to claim 1, wherein said pin is made of metal or plastic.
